(19) United States
(12) Patent Application Publication
(10) Pub. No.: US 2019/0345762 A1
(43) Pub. Date: Nov. 14, 2019

(54) Folding Shade Device

(71) Applicant: Li-Ming Cheng, Kaohsiung (TW)

(72) Inventor: Li-Ming Cheng, Kaohsiung (TW)

(21) Appl. No.: 16/523,036

(22) Filed: Jul. 26, 2019

Related U.S. Application Data
(63) Continuation-in-part of application No. 15/677,108, filed on Aug. 15, 2017.

(51) Int. Cl. E06B 9/44; E06B 9/60

(52) U.S. Cl. CPC E06B 9/44; E06B 2009/2405; E06B 9/60

(57) ABSTRACT

A folding shade device includes a support, a rotating shaft, an adjusting shaft and a shade. The support includes first and second mounting units. The first mounting unit includes a first engagement portion and the second mounting unit includes a second engagement portion. The rotating shaft is rotatably engaged with the first engagement portion of the first mounting unit. The adjusting shaft is made of a non-metal material and includes a first end and a second end. The first end of the adjusting shaft is fitted with the rotating shaft. The second end of the adjusting shaft is rotatably engaged with the second engagement portion of the second mounting unit. The shade includes a first end configured to be fixed around the rotating shaft and the adjusting shaft, and a second end configured to be fixed to a weight.

### CROSS REFERENCE TO RELATED APPLICATION

This is a continuation-in-part application of U.S. patent application Ser. No. 15/677,108 filed on Aug. 15, 2017, and the entire contents of which are incorporated herein by reference.

### BACKGROUND

### 1. Technical Field

The present invention relates to a folding shade device and, more particularly, to a folding shade device including components that can be easily and conveniently cut by a user according to the desired size.

### 2. Description of the Related Art

FIG. 1 shows a conventional folding shade device 9 including a support 91, a shaft 92, a shade 93 and a weight 94. The support 91 includes a motor 911 and a positioning portion 912 respectively at two portions thereof. The motor 911 includes a transmission member 913. A first end of the shaft 92 has a transmission portion 921 coupled with the transmission member 913. A second end of the shaft 92 is coupled with the positioning portion 912. An end of the shade 93 is fixed to a roller 931 coupled to the shaft 92. The roller 931 and the shaft 92 can rotate jointly. The weight 94 is coupled to the other end of the shade 93.

The transmission member 913 drives the shaft 92 to rotate. Thus, the shaft 92 must be made of rigid metal to permit synchronous rotation of the shaft 92 and the transmission member 913 without the risk of loosening, thereby assuring subsequent folding or unfolding of the shade 93.

A user installing the folding shade device 9 can purchase in a shopping mall the desired components according to personal favorites, styles, colors, or the decoration atmosphere. The user can cut the components to the desired sizes meeting a size of a window in a house. However, most families do not have a machine for cutting the shaft 92 which is generally made of metal. Thus, the user must ask help from a factory or a shop, which is extremely inconvenient in use.

Thus, improvement to the conventional folding shade devices is necessary.

### SUMMARY

To solve the above problem, an objective of the present invention is to provide a folding shade device including components that can be easily and conveniently cut by a user according to the desired size.

When the terms “up”, “down”, “inner”, “outer” and similar terms are used herein, it should be understood that these terms have reference only to the structure shown in the drawings as it would appear to a person viewing the drawings and are utilized only to facilitate describing the invention, rather than restricting the invention.

A folding shade device according to the present invention includes a support, a rotating shaft, an adjusting shaft and a shade. The support includes first and second mounting units. The first mounting unit includes a first engagement portion and the second mounting unit includes a second engagement portion. The rotating shaft is rotatably engaged with the first engagement portion of the first mounting unit. The adjusting shaft is made of a non-metal material and includes a first end and a second end. The first end of the adjusting shaft is fitted with the rotating shaft. The second end of the adjusting shaft is rotatably engaged with the second engagement portion of the second mounting unit. The shade has a first end configured to be fixed around the rotating shaft and the adjusting shaft, and a second end configured to be fixed to a weight.

Thus, since the adjusting shaft of the folding shade device according to the present invention is made of a non-metal material, the user can use a cutting tool, that is simple or that can be obtained easily, to cut the adjusting shaft according to the desired length. After cutting, the adjusting shaft is coupled to the rotating shaft. Thus, the size of the folding shade device can be easily adjusted, providing convenience in installation and use.

In an example, the rotating shaft includes a tube and a spring beam received in the tube. The spring beam includes a spring engagement portion rotatably engaged with the first engagement portion of the first mounting unit.

In an example, the spring beam further includes a rod and a spring receiving the rod. The rod includes a first connector and a second connector respectively at two ends thereof. One end of the spring is relatively adjacent to the first connector and another end of the spring is relatively adjacent to the second connector.

In an example, an outer periphery of the spring engagement portion forms a plurality of projections respectively engaged with a plurality of grooves formed on an inner periphery of the tube.

In an example, the folding shade device further includes a plug having a shaft engagement portion engaged with the second engagement portion of the second mounting unit.

In an example, the shaft engagement portion is pivotable relative to the adjusting shaft.

In an example, the rotating shaft is made of metal.

In an example, the adjusting shaft is made of a paper roll or plastic to permit easy cutting.

The present invention will become clearer in light of the following detailed description of illustrative embodiments of this invention described in connection with the drawings.

### BRIEF DESCRIPTION OF THE DRAWINGS

FIG. 1 is an exploded, perspective view of a conventional folding shade device.

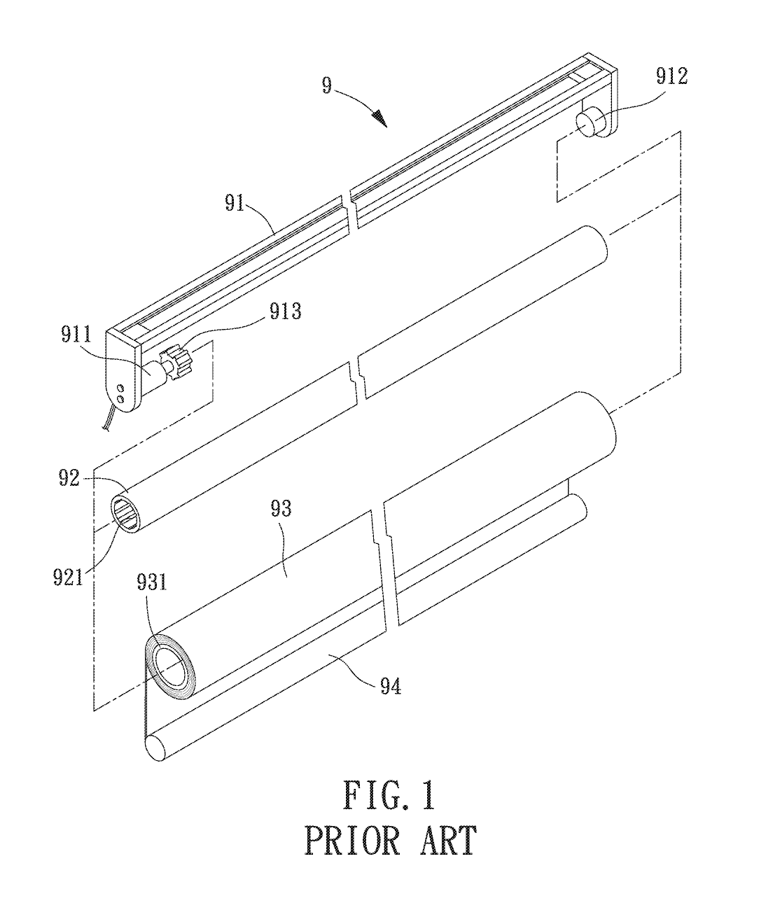

FIG. 2 is an exploded, perspective view of a folding shade device according to the present invention.

FIG. 3 is an enlarged view of a spring beam of the folding shade device according to the present invention.

FIG. 4 is a cross sectional view of the folding shade device of FIG. 2.

FIG. 5 is a cross sectional view of a modified example of the folding shade device of FIG. 4.

### DETAILED DESCRIPTION

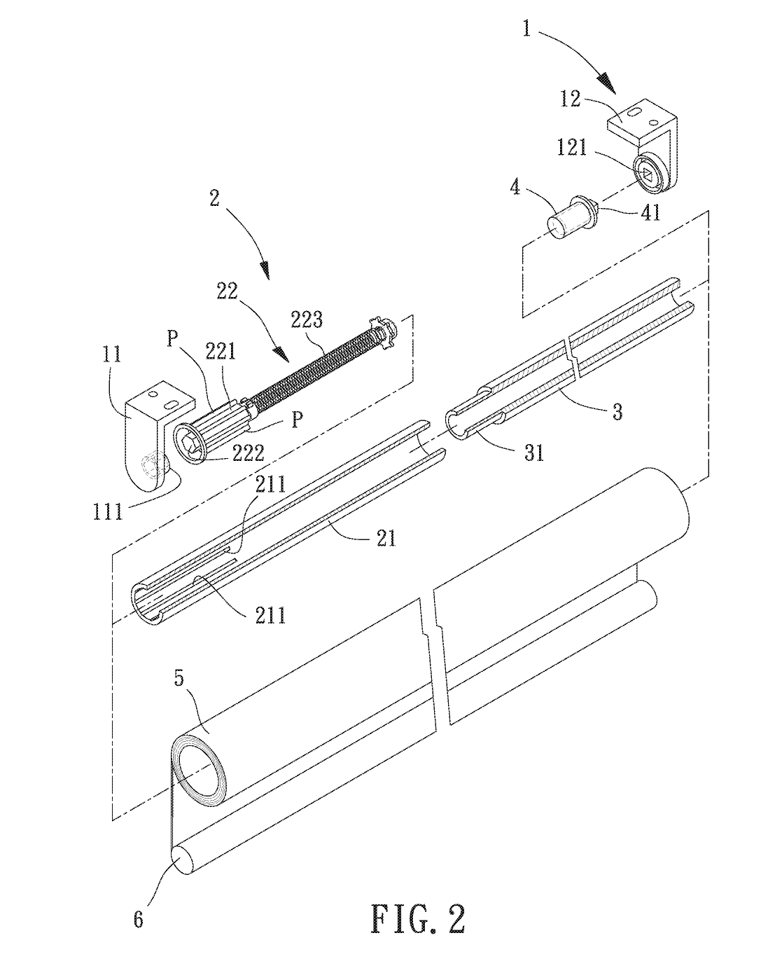

With reference to FIG. 2, a first embodiment of a folding shade device according to the present invention includes a support 1, a rotating shaft 2, an adjusting shaft 3, a plug 4, a shade 5 and a weight 6. The support 1 includes a first mounting unit 11 and a second mounting unit 12. A first end of the rotating shaft 2 is coupled to the first mounting unit 11. A second end of the rotating shaft 2 is coupled to a first end of the adjusting shaft 3. A second end of the adjusting shaft 3 is coupled to the second mounting unit 12. The shade 5 is fitted around the rotating shaft 2 and the adjusting shaft 3.

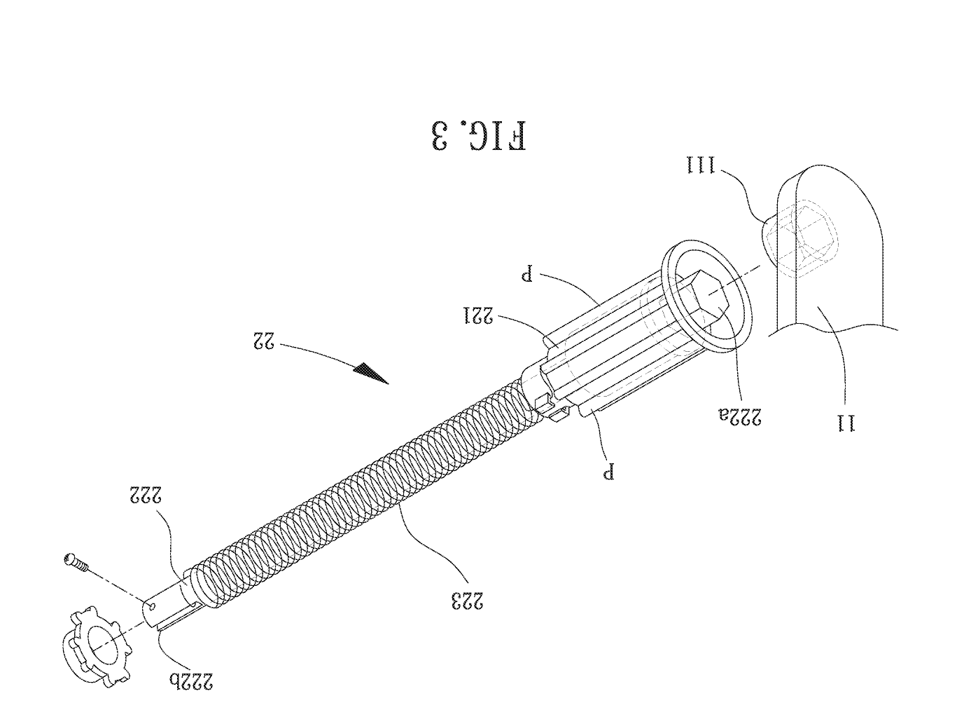

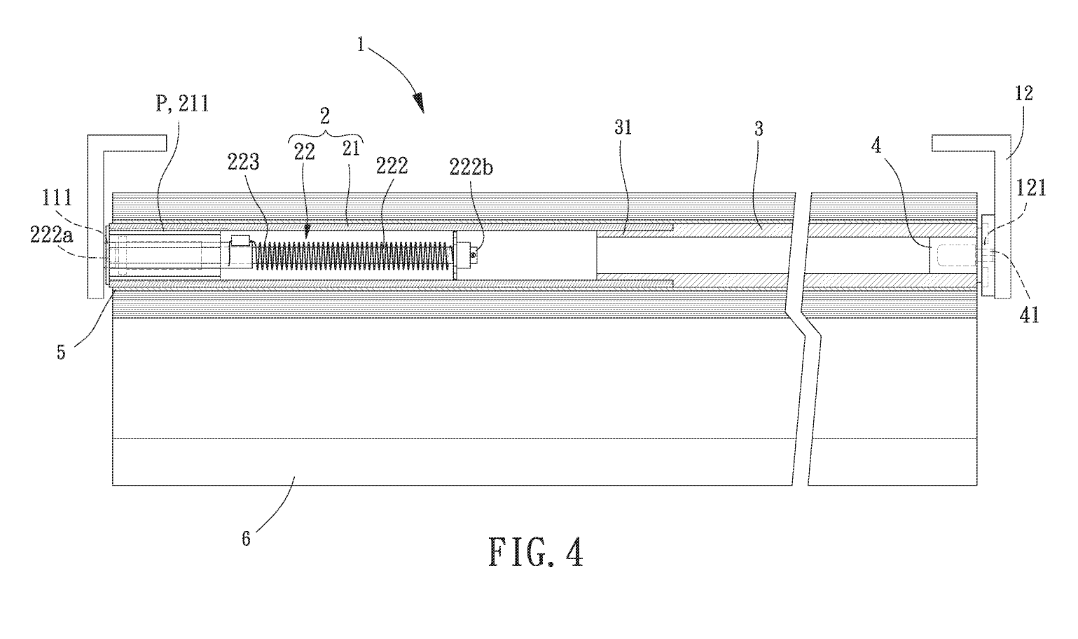

With reference to FIGS. 2, 3 and 4, the first mounting unit 11 includes a first engagement portion 111 and the second mounting unit 12 includes a second engagement portion 121. The rotating shaft 2 includes a tube 21 and a spring beam 22 received in the tube 21. As shown in FIG. 3, the spring beam 22 includes a spring engagement portion 221, a rod 222, and a spring 223 receiving the rod 222. The spring engagement portion 221 is engaged with the first engagement portion 111 of the first mounting unit 11. Specifically, the rod 222 includes a first connector 222a at one end thereof; the spring engagement portion 221 is engaged with the first engagement portion 111 of the first mounting unit 11 via the first connector 222a. The rod 222 further includes a second connector 222b at another end thereof. One end of the spring 223 is relatively adjacent to the first connector 222a and another end of the spring 223 is relatively adjacent to the second connector 222b. The outer periphery of the spring engagement portion 221 forms a plurality of projections P respectively engaged with a plurality of grooves 211 formed on the inner periphery of the tube 21. The tube 21 can pivot about the rod 222. The plug 4 is engaged into the channel of the adjusting shaft 3. The plug 4 is press fit with the inner periphery of the adjusting shaft 3 delimiting the channel. The plug 4 includes a shaft engagement portion 41 engaged with the second engagement portion 121 of the second mounting unit 12. The adjusting shaft 3 can pivot relative to the shaft engagement portion 41.

Still referring to FIGS. 2, 3 and 4, the first end of the rotating shaft 2 is rotatably engaged with the first mounting unit 11. The second end of the rotating shaft 2 is coupled to the first end of the adjusting shaft 3. The rotating shaft 2 is made of metal.

The second end of the adjusting shaft 3 is rotatably engaged with the second mounting unit 12. The first end of the adjusting shaft 3 includes a coupling portion 31 fitted with the second end of the rotating shaft 2. The coupling portion 31 can be fitted with an inner periphery or an outer periphery of the rotating shaft 2. In this embodiment, the coupling portion 31 is fitted in the rotating shaft 2. Furthermore, an outer diameter of the adjusting shaft 3 is equal to an outer diameter of the rotating shaft 2. It is noted that the adjusting shaft 3 is made of a non-metal material, such as a paper roll or plastic. Thus, the user can easily and conveniently cut the adjusting shaft 3 to the desired length.

The shade 5 includes a first end configured to be fixed around the rotating shaft 2 and the adjusting shaft 3, and a second end configured to be fixed to the weight 6. The weight 6 can be in the form of a cylindrical member to provide an aesthetic appearance. Thus, when the rotating shaft 2 and the adjusting shaft 3 rotate, the shade 5 can be coiled upward or pulled downward to an extended state.

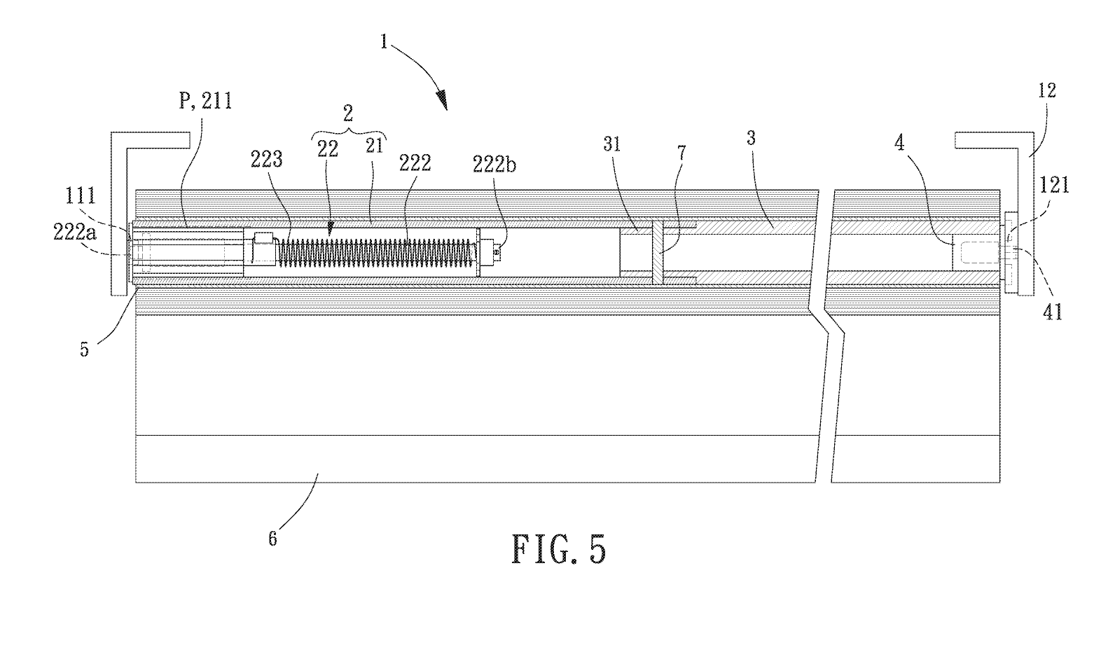

With reference to FIG. 5, after the coupling portion 31 of the adjusting shaft 3 has been fitted with the rotating shaft 2, the rotating shaft 2 and the adjusting shaft 3 can be fixed together by a fixing member 7 to enhance the coupling effect between the rotating shaft 2 and the adjusting shaft 3, permitting synchronous rotation of the rotating shaft 2 and the adjusting shaft 3.

By providing the above structure, in the installation of the folding shade device according to the present invention, since the adjusting shaft 3 is made of a non-metal material and is, thus, easy to cut, the user can use a cutting tool, that is simple or that can be easily obtained, to cut the adjusting shaft 3 according to the desired length. Then, the rotating shaft 2 is fitted with the coupling portion 31 of the adjusting shaft 3. Thus, the size of the folding shade device can be easily adjusted.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A folding shade device comprising:
a support including a first mounting unit and a second mounting unit, wherein the first mounting unit includes a first engagement portion and the second mounting unit includes a second engagement portion;
a rotating shaft rotatably engaged with the first engagement portion of the first mounting unit;
an adjusting shaft made of a non-metal material and including a first end and a second end, wherein the first end of the adjusting shaft is fitted with the rotating shaft, wherein the second end of the adjusting shaft is rotatably engaged with the second engagement portion of the second mounting unit; and
a shade having a first end configured to be fit around the rotating shaft and the adjusting shaft, and a second end configured to be fixed to a weight.

2. The folding shade device as claimed in claim 1, wherein the rotating shaft includes a tube and a spring beam received in the tube, wherein the spring beam includes a spring engagement portion rotatably engaged with the first engagement portion of the first mounting unit.

3. The folding shade device as claimed in claim 2, wherein the spring beam further includes a rod and a spring receiving the rod, wherein the rod includes a first connector and a second connector respectively at two ends thereof, and wherein one end of the spring is relatively adjacent to the first connector and another end of the spring is relatively adjacent to the second connector.

4. The folding shade device as claimed in claim 2, wherein an outer periphery of the spring engagement portion forms a plurality of projections respectively engaged with a plurality of grooves formed on an inner periphery of the tube.

5. The folding shade device as claimed in claim 1, further comprising a plug having a shaft engagement portion engaged with the second engagement portion of the second mounting unit.

6. The folding shade device as claimed in claim 5, wherein the shaft engagement portion is pivotable relative to the adjusting shaft.

7. The folding shade device as claimed in claim 1, wherein the rotating shaft is made of metal.

8. The folding shade device as claimed in claim 1, wherein the adjusting shaft is made of a paper roll or plastic.
